(19) United States
(12) Patent Application Publication
(10) Pub. No.: US 2026/0174121 A1
(43) Pub. Date: Jun. 25, 2026

(54) METHOD OF MANUFACTURING A COMPONENT OF AN AEROSOL PROVISION DEVICE

(71) Applicant: Nicoventures Trading Limited, London (GB)

(72) Inventors: Duck-soo CHOI, London (GB); Jusuek LEE, London (GB); Jonathon LISTER, London (GB)

(21) Appl. No.: 19/124,208

(22) PCT Filed: Oct. 20, 2023
(86) PCT No.: PCT/EP2023/079328

§ 371 Date: Apr. 24, 2025

(30) Foreign Application Priority Data
Oct. 24, 2022 (GB) 2215729.1

(51) Int. Cl. A24F 40/10

(52) U.S. Cl. CPC A24F 40/10

(57) ABSTRACT

A method of manufacturing a component of an aerosol provision device is disclosed, the method comprises providing a non-planar support, and laser activating at least a portion of the support to form one or more laser activated regions.

### CROSS-REFERENCE TO RELATED APPLICATIONS

This present application is a National Phase entry of PCT Application No. PCT/EP2023/079328, filed Oct. 20, 2023, which claims priority from Great Britain Application No. 2215729.1, filed Oct. 24, 2022, each of which are fully incorporated herein by reference in their entireties.

### TECHNICAL FIELD

The present invention relates to a method of manufacturing an aerosol provision device, a component of an aerosol provision device, an aerosol generator, an aerosol provision device, an aerosol provision system and a method of generating an aerosol.

### BACKGROUND

Smoking articles such as cigarettes, cigars and the like burn tobacco during use to create tobacco smoke. Attempts have been made to provide alternatives to these articles by creating products that release compounds without combusting. Examples of such products are so-called “heat not burn” products or tobacco heating devices or products, which release compounds by heating, but not burning, material. The material may be, for example, tobacco or other non-tobacco products, which may or may not contain nicotine.

Aerosol provision systems, which cover the aforementioned devices or products, are known. Common systems use heaters to create an aerosol from a suitable medium which is then inhaled by a user.

It is known to use an induction heater in the form of a helical inductor coil to heat the medium.

Conventional aerosol provision devices comprise a cylindrical heating chamber surrounded by a helical inductor coil into which a rod-shaped consumable is inserted. The size of the device is often dictated by the diameter of the helical inductor coil.

It is desired to provide an improved induction heating assembly for an aerosol provision device.

### SUMMARY

According to an aspect there is provided a method of manufacturing a component of an aerosol provision device comprising:
providing a non-planar support; and
laser activating at least a portion of the support to form one or more laser activated regions.

According to various embodiments an inductor coil is formed by directing a laser onto the surface of the support to form laser activated regions. The support may be formed from a thermoplastic material such as polyetheretherketone (PEEK) which has been doped with a metallic inorganic compound. The laser creates a laser activated region upon the support which can then optionally be (further) metallised using e.g. an electroless plating process to build up one or more conductive layers of e.g. copper.

According to various embodiments the laser is arranged to form a conductor track structure on a non-conductive support. The conductor track structure may be formed of metal nuclei created by breaking up very finely distributed non-conductive metal compounds contained in the support. The non-conductive metal compounds contained in the support material may be broken up or otherwise activated by irradiating portions of the supporting material with electromagnetic radiation. After the laser impinges upon the support, the surface of the support becomes microscopically roughened and a laser direct structuring additive present in the support is activated. As a result of the surface condition an electroless metalisation process may be performed which results in plating a metal layer upon the base layer or the support.

The non-conductive metal compounds may comprise thermally stable inorganic oxides which are stable and insoluble in aqueous acid or alkaline metallization baths, and which are selected from the group consisting of higher oxides which contain at least two different kinds of cations and which have a spinel structure or spinel-related structure, and which remain unchanged in non-irradiated areas of the supporting material.

Classic spinels are mixed metal oxides of magnesium and aluminium, but the magnesium may be wholly or partially replaced by iron, zinc and/or manganese, and the aluminium by iron and/or chromium. Spinel-related mixed oxide structures also may contain nickel and/or cobalt cations.

The one or more laser activated regions may comprise one or more conductive traces or tracks. According to various embodiments, the one or more conductive traces or tracks may comprise one or more copper traces or tracks which may be formed on the support which may comprise an insulator.

According to various embodiments a method of manufacturing a component of an aerosol provision device is disclosed wherein a laser beam from a laser is directed onto a support comprised of, for example, a thermoplastic which is doped with a non-conductive metallic inorganic compound. The support may be non-planar i.e. may be curved and may comprise a three dimensional support as opposed to flat two dimensional support.

The laser may be arranged to impinge upon the surface of the support and may be arranged to cause at least a portion of the support to form one or more laser activated regions. According to various embodiments, the one or more laser activated regions comprise one or more conductive traces or tracks. The one or more conductive traces or tracks may form one or more electrodes on the surface of the support.

Once formed on the support, the one or more laser activated regions essentially form a catalyst or anchoring site upon which one or more (further) conductive layers (e.g. of copper) may optionally be deposited in order to form electrodes upon the surface of the support. The process employed may be referred to as a laser direct structuring (“LDS”) process. In particular, the electrodes which are formed may be arranged to form a spiral or helical induction coil.

According to various embodiments the one or more laser activated regions on the support may comprise a spiral or helical coil electrode arrangement. Embodiments are also contemplated wherein the thickness of the electrode arrangement may be increased by depositing one or more conductive layers upon the one or more laser activated regions.

It will be understood that according to various embodiments whereas the one or more laser activated regions formed on the surface of the support may be essentially flush with the surface of the support (or at least form a microscopically roughened surface), if one or more conductive layers are then deposited upon the laser activated regions then the conductive layers may stand proud from the rest of the surface of the support.

Embodiments are also contemplated wherein the support comprises grooves and one or more laser activated regions are formed in the grooves. Thereafter, one or more conductive layers may be deposited upon the laser activated regions in the grooves. For example, the one or more conductive layers which are deposited in the grooves may be arranged so that once the deposition process is completed, the one or more conductive layers are flush with the rest of the surface of the support.

Optionally, the one or more laser activated layers may have a thickness of: (i)<1 μm; (ii) 1-2 μm; (iii) 2-3 μm; (iv) 3-4 μm; (v) 4-5 μm; (vi) 5-6 μm; (vii) 6-7 μm; (viii) 7-8 μm; (ix) 8-9 μm; or (x) 9-10 μm. According to other embodiments the one or more laser activated layers may have a thickness of: (i)<10 μm; (ii) 10-20 μm; (iii) 20-30 μm; (iv) 30-40 μm; (v) 40-50 μm; (vi) 50-60 μm; (vii) 60-70 μm; (viii) 70-80 μm; (ix) 80-90 μm; or (x) 90-100 μm.

According to another embodiment there is provided a method of manufacturing a component of an aerosol provision device comprising providing a support and laser activating at least a portion of the support to form one or more laser activated regions, wherein the laser activated regions comprise metal nuclei.

Optionally, the method further comprises depositing one or more conductive layers upon the one or more laser activated regions.

According to various embodiments the ability to form conductive layers upon a support using a laser direct structuring (“LDS”) process enables a component of an aerosol provision device to be manufactured with a high degree of customisability. For example, the thickness and/or width of the electrodes may be readily varied so that novel electrode structures can be formed upon the support.

According to an embodiment relatively thin electrodes may initially be formed on the support by the initial laser activation process. According to other embodiments one or more conductive layers may then optionally be further deposited upon the initial electrodes formed in the support so that a thicker electrode arrangement may be formed. The one or more conductive layers which may be deposited upon the laser activated regions may be arranged to have a similar or different template to that of the laser activated regions. For example, a novel electrode structure may be formed wherein the base layer of the electrode comprises laser activated regions having a thickness d1 and width w1 and wherein a first conductive layer is deposited upon the base layer. The first conductive layer may have a thickness d2, wherein for example d2>d1. Also, the first conductive layer may have a width w2, wherein for example w2<w1. As a result, the first conductive layer may comprise an electrode layer which is thicker (deeper) but narrower than the underlying base layer. Optionally, a second conductive layer having a thickness d3 and a width w3 may be deposited upon the first conductive layer. According to an embodiment d3>d2 or alternatively d3<d2. According to an embodiment w3<w2. Accordingly, embodiments are envisaged wherein a second conductive layer is provided on top of the first conductive layer. The second conductive layer may be thicker (deeper) or shallower than the first conductive layer. The second conductive layer may also be narrower in the width direction than both the first conductive layer and the base layer.

According to embodiments, a helical inductor coil may be formed on the support, and the thickness of the inductor coil which is formed may be arranged to vary at different positions along the axial length of the inductor coil. Embodiments are also contemplated wherein the pitch of the inductor coil which is formed and/or the number of turns of the inductor coil per unit length may be arranged to vary at different positions.

Forming one or more conductive layers directly onto the surface of a support also enables a component to be formed which exhibits an improved cooling efficiency whilst also potentially allowing for a more compact design of inductor coil to be provided. It will be understood that a conventional inductor coil may comprise a coil made from LITZ wire wherein the wire has a constant diameter. Accordingly, the disclosed method which may utilise depositing conductive layers upon laser activated regions of a support provides increased flexibility and freedom of design.

Optionally, the one or more conductive layers comprise a metal or a metal alloy.

Optionally, the one or more conductive layers comprise copper, nickel, silver, gold, chromium, palladium, tin, aluminium, platinum, tungsten or zinc.

Optionally, the one or more conductive layers have a thickness of: (i)<10 μm; (ii) 10-20 μm; (iii) 20-30 μm; (iv) 30-40 μm; (v) 40-50 μm; (vi) 50-60 μm; (vii) 60-70 μm; (viii) 70-80 μm; (ix) 80-90 μm; or (x) 90-100 μm.

Optionally, the one or more conductive layers have a square, rectangular or polygonal cross-sectional profile.

Optionally, the support comprises a tubular or hollow structure.

Optionally, the support comprises an electrical insulator.

Optionally, the support comprises a thermoplastic material.

Optionally, the thermoplastic material comprises polyetheretherketone (PEEK).

Optionally, the support is doped with a non-conductive metallic inorganic compound.

Optionally, the one or more laser activated regions comprise metal nuclei.

Optionally, the step of laser activating at least a portion of the support to form one or more laser activated regions comprises laser activating at least a portion of a first surface and/or at least a portion of a second different surface of the support.

Optionally, the step of depositing one or more conductive layers upon the one or more laser activated regions comprises depositing one or more conductive layers upon at least a portion of the first surface and/or upon at least a portion of the second different surface of the support.

Optionally, the first surface comprises an outer surface of the support.

Optionally, the second surface comprises an inner surface of the support.

Optionally, the method further comprises providing an insulator layer or portion upon or adjacent the one or more conductive layers.

Optionally, the one or more laser activated regions and/or the one or more conductive layers may be arranged to form one or more helical coils.

Optionally, the one or more helical coils have a substantially constant pitch, a substantially constant number of turns per unit length or wherein the height of one complete helix turn is substantially constant along at least 90% of the axial length of the one or more helical coils.

Optionally, the one or more helical coils comprise:
a first helical section having a first pitch P1 or P1 turns per unit length or wherein the height of one complete helix turn is P1;
a second different helical section having a second pitch P2 or P2 turns per unit length or wherein the height of one complete helix turn is P2; and
wherein P1≠P2.

Optionally, the one or more helical coils have a substantially constant width and/or a substantially constant length and/or a substantially constant thickness along at least 90% of the axial length of the one or more helical coils.

Optionally, the one or more helical coils comprise:
a first helical section having a width W1 and/or a length L1 and/or a thickness T1;
a second different helical section having a width W2 and/or a length L2 and/or a thickness T2; and
wherein W1≠W2 and/or L1≠L2 and/or T1≠T2.

Optionally, the step of depositing one or more conductive layers upon the one or more laser activated regions comprises using an electroless plating process, a non-electrolytic plating process, a galvanic plating process or an autocatalytic plating process.

Optionally, the electroless plating process, non-electrolytic plating process, galvanic plating process or autocatalytic plating process comprises:
contacting the one or more laser activated regions with a liquid solution so as to trigger a chemical or catalytic reaction which results in the deposition of metal particles present in the liquid solution onto the one or more laser activated regions so as to form the one or more conductive layers.

According to another aspect there is provided a component of an aerosol provision device comprising:
a non-planar support having one or more laser activated regions.

Optionally, the component further comprises one or more conductive layers deposited upon the one or more laser activated regions.

Optionally, the support comprises a tubular or hollow structure.

Optionally, the support comprises an electrical insulator.

Optionally, wherein the support comprises a thermoplastic material.

Optionally, the thermoplastic material comprises polyetheretherketone (PEEK).

Optionally, the support is doped with a non-conductive metallic inorganic compound.

Optionally, the one or more laser activated regions comprise metal nuclei.

Optionally, the one or more laser activated regions are located on at least a portion of a first surface of the support and/or on at least a portion of a second different surface of the support.

Optionally, the one or more conductive layers deposited upon the one or more laser activated regions are located on at least a portion of the first surface of the support and/or on at least a portion of the second different surface of the support.

Optionally, the first surface comprises an outer surface of the support.

Optionally, the second surface comprises an inner surface of the support.

Optionally, the component further comprises an insulator layer or portion provided upon or adjacent the one or more laser activated regions and/or one or more conductive layers.

Optionally, the one or more laser activated regions and/or the one or more conductive layers are arranged to form one or more helical coils.

Optionally, the one or more helical coils have a substantially constant pitch, a substantially constant number of turns per unit length or wherein the height of one complete helix turn is substantially constant along at least 90% of the axial length of the one or more helical coils.

Optionally, the one or more helical coils comprise:
a first helical section having a first pitch P1 or P1 turns per unit length or wherein the height of one complete helix turn is P1;
a second different helical section having a second pitch P2 or P2 turns per unit length or wherein the height of one complete helix turn is P2; and
wherein P1≠P2.

Optionally, the one or more helical coils have a substantially constant width and/or a substantially constant length and/or a substantially constant thickness along at least 90% of the axial length of the one or more helical coils.

Optionally, the one or more helical coils comprise:
a first helical section having a width W1 and/or a length L1 and/or a thickness T1;
a second different helical section having a width W2 and/or a length L2 and/or a thickness T2; and
wherein W1≠W2 and/or L1≠L2 and/or T1≠T2.

Optionally, the one or more conductive layers comprise a metal or a metal alloy.

Optionally, the one or more conductive layers comprise copper, nickel, silver, gold, chromium, palladium, tin, aluminium, platinum, tungsten or zinc.

Optionally, the one or more conductive layers have a thickness of: (i)<10 μm; (ii) 10-20 μm; (iii) 20-30 μm; (iv) 30-40 μm; (v) 40-50 μm; (vi) 50-60 μm; (vii) 60-70 μm; (viii) 70-80 μm; (ix) 80-90 μm; or (x) 90-100 μm.

Optionally, the one or more conductive layers have a square, rectangular or polygonal cross-sectional profile.

According to another aspect there is provide an aerosol generator comprising: a component of an aerosol provision device as described above.

Optionally, the aerosol generator comprises one or more inductive heating elements.

According to another aspect there is provided an aerosol provision device comprising:
an aerosol generator as described above.

According to another aspect there is provided an aerosol provision system comprising:
an aerosol provision device as described above; and
an aerosol generating article for generating an aerosol.

According to another aspect there is provided a method of generating an aerosol comprising:
providing an aerosol provision device as described above; and
at least partially inserting an aerosol generating article for generating an aerosol within the aerosol provision device.

The method may further comprise activating the aerosol provision device.

### BRIEF DESCRIPTION OF THE DRAWINGS

Various embodiments will now be described, by way of example only, and with reference to the accompanying drawings in which:

FIG. 1A is a schematic diagram of a known heating assembly of an aerosol provision device comprising a single inductor coil formed from wire wrapped around a tubular support and shows an aerosol generating article partially inserted into the tubular support and FIG. 1B shows a cross-section of the heating assembly shown in FIG. 1A and shows a tubular susceptor located within the tubular support and an aerosol generating article partially inserted within the tubular susceptor;

FIG. 2 shows an induction heating assembly for an aerosol provision device according to an embodiment wherein a helical inductor coil is formed upon a tubular support by a laser direct structuring (“LDS”) process;

FIG. 3 shows a cross-section of the induction heating assembly shown in FIG. 2 and shows a tubular susceptor located within the support;

FIG. 4 is a flow-chart illustrating various aspects of a laser direct structuring (“LDS”) process which may be utilised in order to form one or more conductive layers upon a support according to various embodiments; and

FIG. 5A is a schematic diagram of an inductor coil formed upon a support according to an embodiment wherein the one or more conductive layers which form the inductor coil have a first width and wherein the inductor coil has a first pitch and FIG. 5B is a schematic diagram of an inductor coil formed upon a support according to another embodiment wherein the one or more conductive layers have a second smaller width and wherein the inductor coil has a second smaller pitch.

### DETAILED DESCRIPTION

Aspects and features of certain examples and embodiments are discussed or described herein. Some aspects and features of certain examples and embodiments may be implemented conventionally and these are not discussed or described in detail in the interests of brevity. It will thus be appreciated that aspects and features of apparatus and methods discussed herein which are not described in detail may be implemented in accordance with conventional techniques for implementing such aspects and features.

According to the present disclosure, a “non-combustible” aerosol provision system is one where a constituent aerosol generating material of the aerosol provision system (or component thereof) is not combusted or burned in order to facilitate delivery of at least one substance to a user.

In some embodiments, the delivery system is a non-combustible aerosol provision system, such as a powered non-combustible aerosol provision system. In some embodiments, the non-combustible aerosol provision system is an electronic cigarette, also known as a vaping device or electronic nicotine delivery system (END), although it is noted that the presence of nicotine in the aerosol generating material is not a requirement.

In some embodiments, the non-combustible aerosol provision system is an aerosol generating material heating system, also known as a heat-not-burn system. An example of such a system is a tobacco heating system.

In some embodiments, the non-combustible aerosol provision system is a hybrid system to generate aerosol using a combination of aerosol generating materials, one or a plurality of which may be heated. Each of the aerosol generating materials may be, for example, in the form of a solid, liquid or gel and may or may not contain nicotine. In some embodiments, the hybrid system comprises a liquid or gel aerosol generating material and a solid aerosol generating material. The solid aerosol generating material may comprise, for example, tobacco or a non-tobacco product.

Typically, the non-combustible aerosol provision system may comprise a non-combustible aerosol provision device and a consumable for use with the non-combustible aerosol provision device.

In some embodiments, the disclosure relates to consumables comprising aerosol generating material and configured to be used with non-combustible aerosol provision devices. These consumables are sometimes referred to as articles throughout the disclosure.

In some embodiments, the non-combustible aerosol provision system, such as a non-combustible aerosol provision device thereof, may comprise a power source and a controller. The power source may, for example, be an electric power source or an exothermic power source. In some embodiments, the exothermic power source comprises a carbon substrate which may be energised so as to distribute power in the form of heat to an aerosol generating material or to a heat transfer material in proximity to the exothermic power source.

In some embodiments, the non-combustible aerosol provision system may comprise an area for receiving the consumable, an aerosol generator, an aerosol generation area, a housing, a mouthpiece, a filter and/or an aerosol-modifying agent.

In some embodiments, the consumable for use with the non-combustible aerosol provision device may comprise aerosol generating material, an aerosol generating material storage area, an aerosol generating material transfer component, an aerosol generator, an aerosol generation area, a housing, a wrapper, a filter, a mouthpiece, and/or an aerosol-modifying agent.

Aerosol generating material is a material that is capable of generating aerosol, for example when heated, irradiated or energized in any other way. Aerosol generating material may, for example, be in the form of a solid, liquid or semi-solid (such as a gel) which may or may not contain an active substance and/or flavourants.

The aerosol generating material may comprise a binder and an aerosol former. Optionally, an active and/or filler may also be present. Optionally, a solvent, such as water, is also present and one or more other components of the aerosol generating material may or may not be soluble in the solvent. In some embodiments, the aerosol generating material is substantially free from botanical material. In particular, in some embodiments, the aerosol generating material is substantially tobacco free.

The aerosol generating material may comprise one or more active substances and/or flavours, one or more aerosol-former materials, and optionally one or more other functional material.

An aerosol generator is an apparatus configured to cause aerosol to be generated from the aerosol generating material. In some embodiments, the aerosol generator is a heater configured to subject the aerosol generating material to heat energy, so as to release one or more volatiles from the aerosol generating material to form an aerosol. In some embodiments, the aerosol generator is configured to cause an aerosol to be generated from the aerosol generating material without heating. For example, the aerosol generator may be configured to subject the aerosol generating material to one or more of vibration, increased pressure, or electrostatic energy.

A consumable is an article comprising or consisting of aerosol generating material, part or all of which is intended to be consumed during use by a user. A consumable may comprise one or more other components, such as an aerosol generating material storage area, an aerosol generating material transfer component, an aerosol generation area, a housing, a wrapper, a mouthpiece, a filter and/or an aerosol-modifying agent. A consumable may also comprise an aerosol generator, such as a heater, that emits heat to cause the aerosol generating material to generate aerosol in use. The heater may, for example, comprise combustible material, a material heatable by electrical conduction, or a susceptor.

Non-combustible aerosol provision systems may comprise a modular assembly including both a reusable aerosol provision device and a replaceable aerosol generating article. In some implementations, the non-combustible aerosol provision device may comprise a power source and a controller (or control circuitry). The power source may, for example, comprise an electric power source, such as a battery or rechargeable battery. In some implementations, the non-combustible aerosol provision device may also comprise an aerosol generating component. However, in other implementations the aerosol generating article may comprise partially, or entirely, the aerosol generating component.

For completeness, aerosol provision devices comprising an inductive element are known. The aerosol provision device may comprise one or more inductors and a susceptor which is arranged to be heated by the one or more inductors.

A susceptor is a heating material that is heatable by penetration with a varying magnetic field, such as an alternating magnetic field. The susceptor may be an electrically-conductive material, so that penetration thereof with a varying magnetic field causes induction heating of the heating material. The heating material may be magnetic material, so that penetration thereof with a varying magnetic field causes magnetic hysteresis heating of the heating material. The susceptor may be both electrically-conductive and magnetic, so that the susceptor is heatable by both heating mechanisms. The aerosol provision device that is configured to generate the varying magnetic field is referred to as a magnetic field generator, herein.

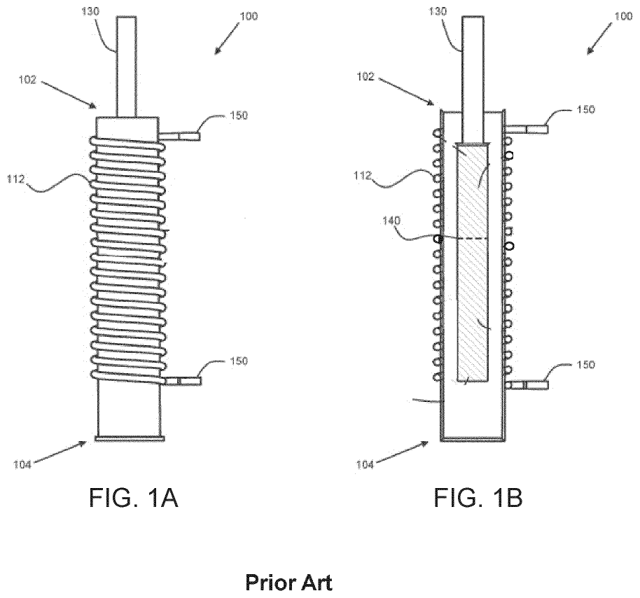

FIG. 1A shows a conventional induction heating assembly 100 for an aerosol provision device and FIG. 1B shows a cross section of the induction heating assembly 100 of the aerosol provision device as shown in FIG. 1A. The heating assembly 100 comprises a tubular support upon which a helical inductor coil 112 is formed from wire. The heating assembly 100 has a first or proximal or mouth end 102 and a second or distal end 104. An aerosol generating article 130 is shown inserted into the tubular support. As shown in FIG. 1B, a tubular susceptor 140 is located within the tubular support and the aerosol generating article 130 is shown partially located within the tubular susceptor 140.

In use an AC electric current is passed through the helical inductor coil 112 which results in the generation of a varying magnetic field which generates eddy currents within the susceptor 140 thereby rapidly heating the susceptor 140. As a result, an aerosol generating article 130 at least partially inserted within the susceptor 140 is rapidly heated and results in aerosol being generated.

In use, a user inhales aerosol which has been formed within the aerosol provision device from the mouth end 102 of the aerosol provision device. The mouth end 102 may be an open end. The heating assembly 100 may be considered as comprising an induction heating unit which comprises the inductor coil 112 and the susceptor 140.

FIGS. 1A and 1B also show an aerosol generating article 130 partially received within a susceptor 140. The susceptor 140 may be formed from any material suitable for heating by induction. For example, the susceptor 140 may comprise metal. In some embodiments, the susceptor 140 may comprise non-ferrous metal such as copper, nickel, titanium, aluminium, tin or zinc and/or ferrous material such as iron, nickel or cobalt. Additionally or alternatively, the susceptor 140 may comprise a semiconductor such as silicon carbide, carbon or graphite.

The susceptor 140 defines a receptacle to surround the aerosol generating article 130 and heat the aerosol generating article 130 externally.

The inductor coil 112 is made from LITZ wire which is wound in a helical fashion to provide a helical inductor coil 112. LITZ wire comprises a plurality of individual wires which are individually insulated and which are twisted together to form a single wire. The inductor coil 112 is made from copper LITZ wire which has a circular cross section.

The inductor coil 112 is configured to generate a varying magnetic field for heating the induction element 114. The inductor coil 112 and the susceptor 140 taken together form an induction heating unit.

The susceptor 140 is hollow and defines a receptacle within which aerosol generating material is received. For example, the aerosol generating article 130 can be inserted into the susceptor 140. The susceptor 140 is tubular with a circular cross section.

The susceptor 140 is arranged to surround the aerosol generating article 130 and heat the aerosol generating article 130 externally. The aerosol provision device is configured such that, when the aerosol generating article 130 is received within the susceptor 140, the outer surface of the aerosol generating article 130 abuts the inner surface of the susceptor 140. This ensures that the heating is most efficient. The aerosol generating article 130 comprises aerosol generating material. The aerosol generating material is positioned within the susceptor 140. The aerosol generating article 130 may also comprise other components such as a filter, wrapping materials and/or a cooling structure.

It will be understood that a LITZ wire is limited to one diameter only i.e. the diameter of a LITZ wire cannot be readily varied across its length. The diameter, number of turns and thickness of the LITZ wire are selected based on the desired target operating temperature to heat an aerosol generating article. These limitations dictate the overall size of the aerosol generating device, as it needs to be sufficiently sized to accommodate the LITZ wire.

In addition, the diameter of the LITZ wire will also dictate the outer skin temperature of the aerosol generating device. The outer skin temperature can be defined as the temperature of the outer surface of the aerosol provision device e.g. the surface that a user will touch when using the aerosol provision device.

In use, once an aerosol generating article has been heated, it is desired to cool the outer skin temperature as quickly as possible, and indeed prevent it from heating up at all. In order to facilitate this when using conventional LITZ wire as the inductor coil, a sufficiently large air gap is required. It will therefore be understood that the presence of an air gap will further increase the size of the aerosol provision device.

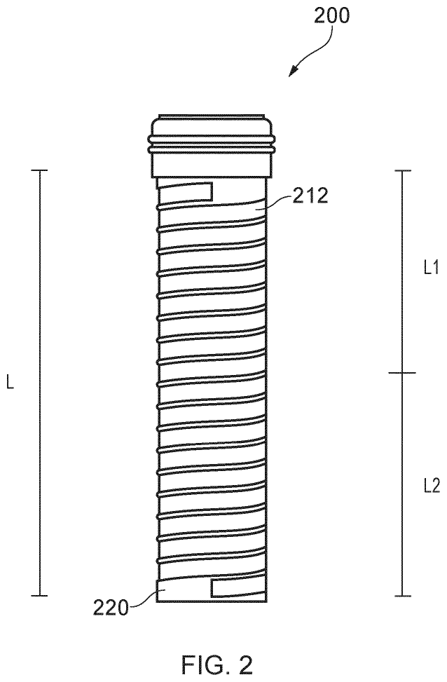

FIG. 2 shows an induction heating assembly 200 for an aerosol provision device according to an embodiment. The heating assembly 200 comprises a support 220 onto which a helical layer of metal has been formed so as to form an inductor coil 212.

The inductor coil 212 is formed by directing a laser (not shown) onto the surface of the support 220 to form laser activated regions. The support 220 may be formed from a thermoplastic material such as polyetheretherketone (PEEK) which has been doped with a metallic inorganic compound. The laser creates a laser activated region upon the support 220 which can then be (further) metallised using e.g. an electroless plating process to build up one or more conductive layers of e.g. copper.

According to various embodiments the laser is arranged to form a conductor track structure on a non-conductive support 220. The conductor track structure may be formed of metal nuclei created by breaking up very finely distributed non-conductive metal compounds contained in the support 220. The non-conductive metal compounds contained in the support material may be broken up or otherwise activated by irradiating portions of the supporting material with electromagnetic radiation.

The non-conductive metal compounds may comprise thermally stable inorganic oxides which are stable and insoluble in aqueous acid or alkaline metallization baths, and which are selected from the group consisting of higher oxides which contain at least two different kinds of cations and which have a spinel structure or spinel-related structure, and which remain unchanged in non-irradiated areas of the supporting material.

Classic spinels are mixed metal oxides of magnesium and aluminium, but the magnesium may be wholly or partially replaced by iron, zinc and/or manganese, and the aluminium by iron and/or chromium. Spinel-related mixed oxide structures also may contain nickel and/or cobalt cations.

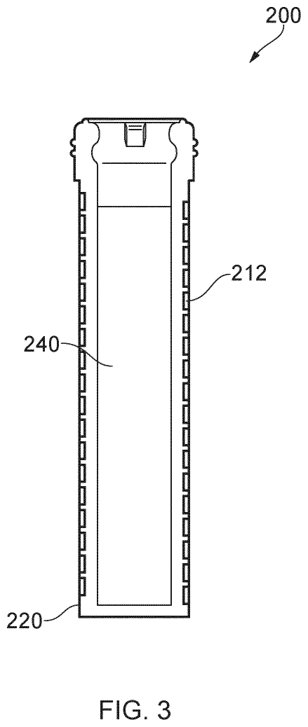

FIG. 3 shows a cross section of the induction heating assembly 200 of FIG. 2. The heating assembly 200 further comprises a susceptor 240 into which an aerosol generating article (not shown) may be received. The susceptor 240 operates in the same way as the susceptor 140 described above with reference to FIGS. 1A and 1B.

The susceptor 240 may be formed from any material suitable for heating by induction. For example, the susceptor 240 may comprise metal. In some examples, the susceptor 240 may comprise non-ferrous metal such as copper, nickel, titanium, aluminium, tin or zinc and/or ferrous material such as iron, nickel or cobalt. Additionally or alternatively, the susceptor 240 may comprise a semiconductor such as silicon carbide, carbon or graphite.

The susceptor 240 may have any suitable shape. In the embodiment shown in FIG. 3, the susceptor 240 defines a receptacle to surround an aerosol generating article (not shown) and to heat the aerosol generating article externally. In other embodiments (not shown), one or more susceptors may be substantially elongate, arranged to penetrate an aerosol generating article and heat the aerosol generating article internally.

The inductor coil 212 is configured to generate a varying magnetic field for heating the susceptor 240 and operates in substantially the same way as the inductor coil 112 as described above with reference to FIGS. 1A and 1B. The varying magnetic field generates eddy currents within the susceptor 240 thereby rapidly heating the susceptor 240 to a maximum operating temperature within a short period of time from supplying the alternative current to the inductor coil 212 e.g. within 20, 15, 12, 10, 5, or 2 seconds. The susceptor 240 may comprise a single susceptor. Alternatively, multiple susceptors 240 may be provided.

Ends of the inductor coil 212 (not shown) may be connected to a controller such as a PCB (not shown). The controller may comprise a proportional integral derivative (“PID”) controller.

According to various embodiments the susceptor 240 may be hollow and may form or define a receptacle within which aerosol generating material may be received. For example, an aerosol generating article (not shown) may be inserted into the susceptor 240. In this example the susceptor 240 is tubular, with a circular cross section. The susceptor 240 is arranged to surround the aerosol generating article to heat the aerosol generating article externally.

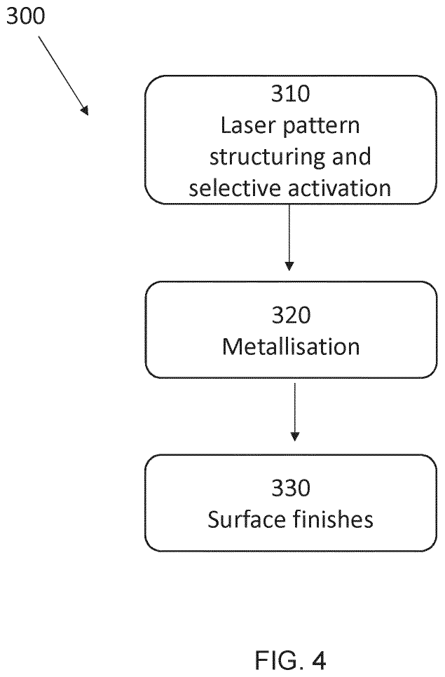

According to various embodiments the inductor coil 212 may be formed on the support 220 using a process known as laser direct structuring (“LDS”) which will be described in more detail below with reference to FIG. 4.

According to various embodiments a laser is used to activate the surface of the support 220 which comprises a thermoplastic material such as polyetheretherketone (PEEK) which may have been doped with a metallic inorganic compound. The laser creates one or more laser activated regions upon the support 220 which can then (optionally) be (further) metallised using e.g. an electroless plating process to build up one or more conductive layers of e.g. copper.

According to the embodiment shown in FIGS. 2 and 3, an inductor coil 212 has been deposited upon the support 220 so as to form a uniform helical inductor coil 212. However, other embodiments are also contemplated wherein the inductor coil 212 may be formed upon the support 220 so as to have a different configuration.

Furthermore, although the inductor coil 212 shown in FIGS. 2 and 3 may be formed by depositing one or more conductive layers upon regions of the support 220 which have been laser activated, it should be understood that depositing one or more conductive layers upon the laser activated regions is not essential. For example, embodiments are contemplated wherein the laser activated regions form conductive traces or tracks which form an electrode structure of the inductor coil 212.

It is also contemplated that various novel electrode structures may be created. For example, the coil 212 may be arranged to have a thickness which is different or which varies along the length of the coil 212. It is contemplated, for example, that the thickness of the coil 212 may not be constant. It is known the magnetic field strength of a coil is given by:

$$H = \frac{I \times N}{L} \qquad ( 1 )$$

wherein H is the strength of the magnetic field in ampere-turns/metre (At/m), N is the number of turns of the coil, I is the current flowing through the coil in amps (A) and L is the length of the coil in metres (m).

The resistance R of a wire (electrode) is known to be inversely proportional to the cross sectional area of the wire (electrode):

$$R = \frac{ρ L}{A} \qquad ( 2 )$$

wherein ρ is the resistivity, L is the length of the wire (electrode) and A is the cross-sectional area of the wire (electrode).

Accordingly, as the cross-sectional area A of the wire (electrode) increases then it will be understood that the resistance of the wire (electrode) will decrease. As a result, for a given voltage a larger current may be passed through a wire (electrode) having a relatively large cross-sectional area compared to through a wire (electrode) having a relatively low cross-sectional area.

From Eqn. 1 above it follows that the magnetic field strength increases for a wire (electrode) having a relatively large cross-sectional area.

Accordingly, providing a coil or electrode structure 212 wherein the thickness of the coil or electrode is different at different positions along the length of the coil or electrode 212 enables the magnetic field strength along the length of the coil or electrode 212 to vary. For example, according to an embodiment the coil or electrode 212 may comprise a first section having a first cross-sectional area and a second section having a second different cross-sectional area. As a result, the resulting magnetic field strength resulting from an alternating current being passed through the two sections may also differ. As a result, a first current may be induced in a first corresponding portion of a susceptor and a second different current may be induced in a second different portion of the susceptor (or in a separate susceptor). This enables the resulting heating effect to be different in the two different sections of the susceptor.

According to various embodiments providing a coil or electrode 212 having a portion having an increased thickness or cross-sectional area enables a higher magnitude magnetic field to be generated than a coil or electrode 212 having a smaller thickness or cross-sectional area. As result, a coil or electrode 212 may be provided which results in different heating characteristics at different axial positions along the axial length of the aerosol provision device. For example, an area of increased thickness will heat the area of the susceptor 240 that it is adjacent to a higher degree than an area of reduced thickness.

According to various embodiments the coil or electrode 212 may have a uniform thickness and/or width or a varied thickness and/or width along its length. According to various embodiments the coil or electrode 212 may have a rectangular cross-sectional profile having a width in a direction parallel to the surface of the support 220 and a depth or thickness in a direction perpendicular to the surface of the support 220. The coil or electrode 212 may have a width: (i)<10 μm; (ii) 10-20 μm; (iii) 20-30 μm; (iv) 30-40 μm; (v) 40-50 μm; (vi) 50-60 μm; (vii) 60-70 μm; (viii) 70-80 μm; (ix) 80-90 μm; (x) 90-100 μm; or (xi)>100 μm. The coil or electrode 212 may have a depth or thickness: (i)<10 μm; (ii) 10-20 μm; (iii) 20-30 μm; (iv) 30-40 μm; (v) 40-50 μm; (vi) 50-60 μm; (vii) 60-70 μm; (viii) 70-80 μm; (ix) 80-90 μm; (x) 90-100 μm; or (xi)>100 μm.

According to various embodiments the coil or electrode 212 may have a relatively thin thickness (e.g. <1 μm) if the coil or electrode 212 comprises solely laser activated regions of the support 220. The thickness of the coil or electrode 212 may be increased by depositing one or more conductive layers upon the laser activated regions. The one or more conductive layers which are deposited upon the laser activated regions may have a thickness >10 μm.

According to various embodiments the coil or electrode 212 may have a cross-sectional area selected from the group consisting of: (i)<100 μm²; (ii) 100-200 μm²; (iii) 200-300 μm²; (iv) 300-400 μm²; (v) 400-500 μm²; (vi) 500-600 μm²; (vii) 600-700 μm²; (viii) 700-800 μm²; (ix) 800-900 μm²; (x) 900-1000 μm²; or (xi)>1000 μm².

According to various embodiments the coil or electrode 212 may have a constant number of turns per unit length or the number of turns per unit length may be different at different sections of the coil or electrode 212. For example, and with reference to FIG. 2, the coil has a total length L and the coil may be considered as comprising two sections. In the example shown in FIG. 2, the coil 212 comprises two equal sections L1 and L2 i.e. length L1 is the same as the length L2 and the number of turns per unit length in section L1 is the same as the number of turns per unit length in section L2. However, embodiments are contemplated wherein the number of turns per unit length may be greater in section L1 than the number of turns per unit length in section L2 or vice versa. Embodiments are contemplated wherein the coil 212 may comprise a plurality of sections and wherein at least some of the sections may have a different or the same number of turns per unit length.

The variation in the number of turns can increase or decrease the rate at which the susceptor 240 can reach a maximum operating temperature. Such an arrangement may provide asymmetrical heating of an aerosol generating article along the length of the aerosol generating article, if desired.

In examples, the pitch of coil 212 may not remain constant. Varying the pitch of the coil 212 pitch can change the heating characteristics of the aerosol provision device at different location of the coil 212. For example, an area of reduced pitch will mean there is an increased number of turns per unit length, thereby heating the area of a susceptor 240 that it is adjacent to a higher degree than an area adjacent a section of the coil 212 which has a lower number of turns per unit length.

As will be appreciated, the number of turns of a coil is inversely proportional to its pitch. Thus, the variation in the pitch of the coil 212 in turn leads to a variation in the number of turns of the coil 212 which can increase or decrease the rate at which the susceptor 240 can reach a maximum operating temperature. Such an arrangement may provide asymmetrical heating of the aerosol generating article along the length of the aerosol generating article, if desired.

According to various embodiments the coil 212 may have a substantially constant pitch per unit length, and therefore a substantially constant number of turns per unit length. The height of one complete helix turn in coil 212 may be substantially constant along at least 90%, 91%, 92%, 93%, 94%, 95%, 96%, 97%, 98% or 99% of the axial length of the coil 212.

In examples, the coil 212 can have a helical section having a first pitch P1 or P1 turns per unit length i.e, wherein the height of one complete helix turn is P1, a second different helical section having a second pitch P2 or P2 turns per unit length i.e, wherein the height of one complete helix turn is P2, such that P1≠P2.

In examples, the coil 212 can have a substantially constant width and/or a substantially constant length and/or a substantially constant thickness along at least 90%, 91%, 92%, 93%, 94%, 95%, 96%, 97%, 98% or 99% of the axial length of the respective coil.

In examples, the coil 212 can have a first helical section having a width W1 and/or a length L1 and/or a thickness T1, a second different helical section having a width W2 and/or a length L2 and/or a thickness T2, such that W1≠W2 and/or L1≠L2 and/or T1≠T2. It will be understood that such configurations are not possible with a conventional inductor coil such as that described with reference to FIGS. 1A and 1B, because the number of turns per unit length is constant, and a LITZ coil is of a constant thickness and diameter.

The coil 212 (or more generally electrode arrangement) may be formed, deposited or coated in the support 220 and/or onto the support 220 such that the coil 212 or electrode arrangement has a square, rectangular or polygonal cross-sectional profile. The support 220 may comprise a thermoplastic material such as polyetheretherketone (“PEEK2). According to various embodiments the diameter of the coil 212 or electrode arrangement may be in the range <10 mm, 10-11 mm, 11-12 mm, 12-13 mm, or 14-15 mm.

Utilising a laser direct structuring process to form a coil 212 or electrode arrangement in and/or on a support 220 results in a coil 212 or electrode arrangement being formed which is integrated with or into the support 220. This advantageously reduces the diameter of the support 220 required (in the case where the support 220 has a tubular structure) compared to conventional arrangements, such as those described with reference to FIGS. 1A and 1B. It will be understood that integrating the coil 212 into a shaped support 220 enables a more compact arrangement to be provided.

The compact support 220 of the disclosed arrangement also means that any air gap between the support 220 and a housing of an aerosol provision device can be reduced as compared to conventional arrangements, such as those described with reference to FIGS. 1A and 1B. This also results in more efficient cooling. The improved efficiency enables a smaller battery to be utilised in order to power the aerosol provision device in use thereby reducing recharge times. Overall, a more compact, lighter, robust, customisable and more energy efficient heating arrangement may be provided.

In the embodiment shown in FIGS. 2 and 3, the coil or electrode 212 may be formed by depositing, coating or otherwise forming an electrode structure onto an exterior surface of the support 220. However in other examples, the coil 212 or electrode structure can be deposited, coated or otherwise formed on an interior surface of the support 220 via a laser direct structuring process.

According to an embodiment the length L of the coil 212 may be substantially 585 mm, the total number of turns may be 18 and the coil pitch may be substantially 2 mm. However, other embodiments are contemplated wherein the length L of the coil 221 may be shorter or longer than 585 mm. Similarly, the number of turns may be less or greater than 18. It is also contemplated that the coil pitch may be less than 2 mm or greater than 2 mm.

FIG. 4 shows a flow-chart illustrating the steps involved in a laser direct structuring process 300 as utilised according to various embodiments in order to form, for example, a helical induction coil upon a support. According to a first step 310 a laser is used to laser pattern structuring and selectively activate a region of the support. The support may comprise a thermoplastic material such as polyetheretherketone (PEEK). The support may be formed by an injection moulding processes.

According to various embodiments the support may be moulded from a material having a high thermal stability, good isotropic component behaviour and which is suitable for metallisation. PEEK has been found to be particularly suitable for the process but other materials may be used including polyphthalamide (PPA) or liquid crystal polymer (LCP).

The support may be formed from a thermoplastic which is doped with a non-conductive metallic inorganic compound. For example, the non-conductive metallic inorganic compound may include copper. However, other embodiments are contemplated where the additive may include nickel, silver, gold, chromium, palladium, tin, aluminium, platinum, tungsten or zinc.

According to various embodiments the support may be made from a thermoplastic having a composition comprising: (i) 20 to 90 wt % of a thermoplastic resin; (ii) a laser direct structuring additive; and (iii) optionally ceramic filler particles which may not have a laser direct structuring additive function.

According to various embodiments the laser direct structuring additive may comprise a non-conductive metallic inorganic compound. However, other embodiments are contemplated wherein the laser direct structuring additive may comprise a conductive metal oxide. The conductive metal oxide may have a resistivity of at most 5×10³ Ω·cm. The conductive metal oxide may comprise at least a metal of Group n of the periodic table and/or a metal of Group n+1, wherein n is an integer of 3 to 13. Suitable metals of Group n and/or Group n+1 of the periodic table include, for example, Group 4 (titanium, zirconium), Group 5 (vanadium, niobium), Group 6 (chromium, molybdenum), Group 7 (manganese), Group 8 (iron, ruthenium), Group 9 (cobalt, rhodium, iridium), Group 10 (nickel, palladium, platinum), Group 11 (copper, silver, gold), Group 12 (zinc, cadmium) and Group 13 (aluminium, gallium, indium). Suitable metals of Group n of the periodic table further include metals of Group 3 (scandium, yttrium). Suitable metals of Group n+1 of the periodic table further include metals of Group 14 (germanium, tin). The conductive metal oxide may comprise zinc and aluminium. For example, the conductive metal oxide may comprise an aluminium-doped zinc oxide.

According to another embodiment the laser direct structuring additive may comprise calcium copper titanate. The thermoplastic resin may comprise a resin such as a polycarbonate in particular aromatic polycarbonate, polyamide, polyester, polyesteramide, polystyrene, polymethyl methacrylate, polyphenylene ether, liquid crystal polymer (LCP), polyether ether ketone (PEEK), cyclic olefin (co) polymer (COP) or combinations thereof. The resins may be homopolymers, copolymers or mixtures thereof, and may be branched or non-branched.

According to various embodiments a conductor track structure may be formed on a non-conductive supporting material comprising a metallized layer which is applied to metal nuclei created by breaking up very finely distributed non-conductive metal compounds contained in the supporting material. The non-conductive metal compounds contained in the supporting material may be broken up or otherwise activated by irradiating portions of the supporting material with electromagnetic radiation. The non-conductive metal compounds may comprise thermally stable inorganic oxides which are stable and insoluble in aqueous acid or alkaline metallization baths, and which are selected from the group consisting of higher oxides which contain at least two different kinds of cations and which have a spinel structure or spinel-related structure, and which remain unchanged in non-irradiated areas of the supporting material. Classic spinels are mixed metal oxides of magnesium and aluminium, but the magnesium may be wholly or partially replaced by iron, zinc and/or manganese, and the aluminium by iron and/or chromium. Spinel-related mixed oxide structures also may contain nickel and/or cobalt cations.

According to various embodiments a conductor track structure may be formed on a non-conductive support having at least a surface formed of a non-conductive supporting material having at least one thermally stable, spinel-based, non-conductive metal oxide which is stable and insoluble in aqueous acid or alkaline metallization baths dispersed therein. The process involves irradiating areas of the support on which conductive tracks are to be formed with electromagnetic radiation to break down the non-conductive metal oxides and release metal nuclei, and subsequently metallizing the irradiated areas by chemical reduction. According to various embodiments non-conductive metal compounds of thermally highly stable inorganic oxides which are stable and insoluble in aqueous acid or alkaline metallization baths and which are higher oxides having the structure of spinels or structures that are similar to the spinel structures may be used. As a result these metal compounds may remain unchanged on the surface of the supporting material even in non-irradiated areas. The inorganic oxides used may be resistant to heat so that they remain stable even after having been exposed to soldering temperatures i.e. they do not become electrically conductive and they remain stable in a bath used for metallization.

According to various embodiments the spinel or spinel-related structure may contain copper, chromium, iron, cobalt, nickel or a mixture of two or more of the foregoing. In particular the spinel or spinel-related structure may comprise copper.

The electrically non-conductive supporting material may comprise a thermoplastic or a thermosetting synthetic resin material. The non-conductive supporting material may contain one or more inorganic fillers e.g. silicic acid and/or silicic acid derivatives.

According to various embodiments a spinel-based thermally stable non-conductive higher oxide may be utilised which contains at least two different kinds of cations and which are stable and insoluble in aqueous acid or alkaline metallisation baths. The cations are mixed into the supporting material and the supporting material may then be processed into a component or may be applied to a component as a coating. During the process of laser direct structuring metal nuclei are released using electromagnetic radiation in the area of the conductor structures that are to be produced and these areas are then metallised by chemical reduction, the inorganic metal compound in the form of the spinel-based higher oxides can remain on the surface of the supporting material in the non-irradiated areas. The inorganic higher oxides which contain at least two different kinds of cations used are furthermore sufficiently resistant to heat so that it is possible to use compounding or injection molding of modern high-temperature plastics.

Electromagnetic radiation may be used to simultaneously release metal nuclei and effect ablation while forming an adhesion-promoting surface. This provides a simple means to achieve excellent adhesive strength of subsequently deposited metallic conductor tracks.

The inorganic oxides may contain copper, chromium, iron, cobalt, nickel or mixtures thereof. The non-conductive supporting material may comprise a thermoplastic or a thermosetting synthetic resin material. However, other embodiments are contemplated wherein the supporting material may comprise a non-conductive material such as a ceramic. The non-conductive supporting material may contain one or more inorganic fillers e.g. silicic acid and/or silicic acid derivatives.

According to various embodiments a laser may be used to produce a beam of electromagnetic radiation which may be directed onto the surface of the support in order to release metal nuclei at locations where the laser beam impinges upon the surface of the support. The metal nuclei which are released effectively form a catalyst or anchor for the subsequent (optional) depositing of one or more conductive layers upon the laser activated regions by immersing the support 220 in a bath. The wavelength of the laser may be, for example, 248 nm, 308 nm, 355 nm, 532 nm, 1064 nm or 10600 nm.

It will be understood, that according to various embodiments it is not essential to deposit one or more conductive layers upon the laser activated regions. Instead, embodiments are contemplated wherein the resulting laser activated regions may comprise metal nuclei such as copper atoms which have essentially been liberated from the doped thermoplastic support. The metal nuclei forming the laser activated regions may have a depth <1 μm or 1-10 μm and may form conductive traces or tracks on the surface of the support.

At the first step 310, a laser beam is directed onto portions of the support. The laser activates the surface of the thermoplastic material of the support so that metal nuclei are formed or liberated from the support on the surface of the support. The metal nuclei may form a thin surface layer having a thickness <5 μm or <1 μm. In addition to activating the additive in the support in order to form a laser activated region comprising metal nuclei, the laser beam may also form a microroughened surface which assists with helping one or more layers of conductive material to anchor to the laser activated region during a subsequent optional metallisation step 320.

It is contemplated that the surface roughness of the surface of the conductive pattern may be in the range <0.025 μm, 0.025-0.05 μm, 0.05-1 μm, 0.1-1 μm, 1-5 μm, 5-10 μm, 10-15 μm or >15 μm. According to other embodiments the surface roughness may be in the range of <0.1 μm, 0.1-1 μm, 1-10 μm, 10-20 μm, 20-30 μm, 30-40 μm, 40-50 μm or >50 μm.

If the desired thickness of the electrode structure which is desired to be formed on the support is greater than the thickness of the laser activated region formed at step 310 with the laser structuring and activation process, an optional metallisation step 320 can be used in order to further increase the thickness of the electrode structure which is formed upon the surface of the support. Prior to carrying out a second step 320, the support having a laser activated region formed therein may be cleaned. The support can be cleaned by any suitable conventional process, including spraying with water-based, semi-aqueous or solvent-based cleaning solutions, or by ultrasonic cleaning methods which are known in the art. Once the cleaning the process is complete, a metallisation step 320 may then be initiated, which may act to deposit one or more conductive layers onto the conductive tracks initially formed in the support.

The metallisation step 320 adds to the laser activated additive layer using an electroless metallisation process. The support can be placed in a bath where electroless metallisation may be arranged to take place. The bath can, for example, comprise copper, nickel, silver, gold, chromium, palladium, tin, aluminium, platinum, tungsten or zinc. When placed in the bath, conductive tracks or traces formed on the support may have their thickness increased at a rate in the range of 8-12 μm/h. This process can be carried out until a desired thickness of electrode structure is obtained.

It will be appreciated that each conductive layer can comprise the same conductive material e.g. copper or there a series layers may be deposited each comprising a different material selected from copper, nickel, silver, gold, chromium, palladium, tin, aluminium, platinum, tungsten or zinc. The one or more conductive layers which are deposited upon the laser activated regions may each have a thickness of: (i)<10 μm; (ii) 10-20 μm; (iii) 20-30 μm; (iv) 30-40 μm; (v) 40-50 μm; (vi) 50-60 μm; (vii) 60-70 μm; (viii) 70-80 μm; (ix) 80-90 μm; or (x) 90-100 μm.

After the metallisation step 320 is completed, a final (and optional) surface finish step 330 may be carried out. In step 330, optional and application-specific coatings may be deposited on top of the built-up conductive tracks or electrodes using the same or similar electroless metallisation process as described above with reference to step 320. For example, the support 220 may be placed into a bath contain the desired coating. Coatings can include copper, nickel, silver, gold, chromium, palladium, tin, aluminium, platinum, tungsten or zinc.

Although the above steps 320, 330 refer to electroless metallisation, other plating techniques are also contemplated, including a non-electrolytic plating, a galvanic plating or an autocatalytic plating process wherein the one or more laser activated regions may be contacted with a liquid solution so as to trigger a chemical or catalytic reaction that deposits metal particles present in the liquid solution onto the one or more laser activated regions so as to form the one or more conductive layers.

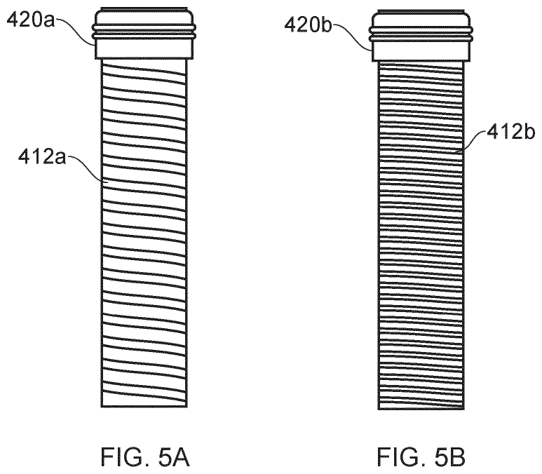

FIGS. 5A and 5B show other inductor coil variations on a support formed using the above described laser direct structuring process according to various embodiments. As described above with reference to the embodiment shown in FIGS. 2 and 3, an inductor coil can be been deposited, coated or otherwise formed onto a support by laser direct structuring in the form of a helical inductor coil, such as a coil 212. It will be understood that by the application of laser direct structuring, the inductor coil can be deposited, coated or otherwise formed onto the support in a number of different configurations.

For example, coil 412a as formed on support 420a as shown in FIG. 5A has a coil pitch that is greater than the pitch of a coil 412b formed on a support 420b as shown in FIG. 5B. Thus, the number of turns per unit length of coil 412a is less than the number of turns per unit length of coil 412b.

Although coils 412a and 412b are shown as having a constant pitch along their length, the coils 412a,412b can have a varied pitch along their respective length i.e. the pitch of coils 412a,412b may not be constant. Varying the pitch of the coils 412a,412b can change the heating characteristics of the aerosol provision device at different location of the coils 412a,412b. For example, an area of reduced pitch will mean that there is an increased number of turns per unit length, thereby heating a corresponding region or area of a susceptor (not shown) that it is adjacent to a higher degree than a region or area of the susceptor which is adjacent a section of the coil which has fewer turns per unit length.

As will be appreciated, the number of turns of a coil is inversely proportional to its pitch. Thus, any variation in the pitch of coils 412a,412b in turn leads to a variation in the number of turns of each coil 412,412b which can increase or decrease the rate at which a susceptor (not shown) can reach a maximum operating temperature. Such an arrangement may provide asymmetrical heating of an aerosol generating article along the length of the aerosol generating article, if desired.

In examples, coils 412a,412b can have a substantially constant pitch, and therefore a substantially constant number of turns per unit length. The height of one complete helix turn in coils 412a, 412b can be substantially constant along at least 90%, 91%, 92%, 93%, 94%, 95%, 96%, 97%, 98% or 99% of the axial length of the one or more helical coils. In examples, coil 412a and/or coil 412b can have a helical section having a first pitch P1 or P1 turns per unit length i.e, wherein the height of one complete helix turn is P1, a second different helical section having a second pitch P2 or P2 turns per unit length i.e, wherein the height of one complete helix turn is P2, such that P1 P2. In examples, coil 412a and/or coil 412b has a first helical section having a width W1 and/or a length L1 and/or a thickness T1 and a second different helical section having a width W2 and/or a length L2 and/or a thickness T2, such that W1 #W2 and/or L1 #L2 and/or T1 #T2. Alternatively, coil 412a and/or coil 412b can have a substantially constant width and/or a substantially constant length and/or a substantially constant thickness along at least 90%, 91%, 92%, 93%, 94%, 95%, 96%, 97%, 98% or 99% of the axial length of the respective coil.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilised and modifications may be made without departing from the scope of the claimed invention. Various embodiments of the invention may suitably comprise, consist of, or consist essentially of, appropriate combinations of the disclosed elements, components, features, parts, steps, means, etc, other than those specifically described herein. In addition, this disclosure may include other inventions not presently claimed, but which may be claimed in future.

1. A method of manufacturing a component of an aerosol provision device comprising:
providing a non-planar support; and
laser activating at least a portion of the support to form one or more laser activated regions.

2. A method as claimed in claim 1, further comprising depositing one or more conductive layers upon the one or more laser activated regions.

3. (canceled)

4. (canceled)

5. The method of claim 2, wherein the one or more conductive layers have a thickness of: (i)<10 μm; (ii) 10-20 μm; (iii) 20-30 μm; (iv) 30-40 μm; (v) 40-50 μm; (vi) 50-60 μm; (vii) 60-70 μm; (viii) 70-80 μm; (ix) 80-90 μm; or (x) 90-100 μm.

6. The method of claim 2, wherein the one or more conductive layers have a square, rectangular or polygonal cross-sectional profile.

7. The method of claim 1, wherein the support comprises a tubular or hollow structure.

8. The method of claim 1, wherein the support comprises an electrical insulator.

9. The method of claim 1, wherein the support comprises a thermoplastic material.

10. (canceled)

11. The method of claim 1, wherein the support is doped with a non-conductive metallic inorganic compound.

12. The method of claim 1, wherein the one or more laser activated regions comprise metal nuclei.

13. The method of claim 1, wherein the step of laser activating at least a portion of the support to form one or more laser activated regions comprises laser activating at least a portion of a first surface and/or at least a portion of a second different surface of the support.

14. The method of claim 13, wherein the step of depositing one or more conductive layers upon the one or more laser activated regions comprises depositing one or more conductive layers upon at least a portion of the first surface and/or upon at least a portion of the second different surface of the support.

15. The method of claim 13, wherein the first surface comprises an outer surface of the support.

16. The method of claim 13, wherein the second surface comprises an inner surface of the support.

17. The method of claim 1, further providing an insulator layer or portion upon or adjacent the one or more laser activated regions and/or one or more conductive layers.

18. The method of claim 1, wherein the one or more laser activated regions and/or the one or more conductive layers are arranged to form one or more helical coils.

19. The method of claim 18, wherein the one or more helical coils have a substantially constant pitch, a substantially constant number of turns per unit length or wherein the height of one complete helix turn is substantially constant along at least 90% of the axial length of the one or more helical coils.

20. The method of claim 18, wherein the one or more helical coils comprise:
a first helical section having a first pitch P1 or P1 turns per unit length or wherein the height of one complete helix turn is P1;
a second different helical section having a second pitch P2 or P2 turns per unit length or wherein the height of one complete helix turn is P2; and
wherein P1≠P2.

21. The method of claim 18, wherein the one or more helical coils have a substantially constant width and/or a substantially constant length and/or a substantially constant thickness along at least 90% of the axial length of the one or more helical coils.

22. The method of claim 18, wherein the one or more helical coils comprise:
a first helical section having a width W1 and/or a length L1 and/or a thickness T1;
a second different helical section having a width W2 and/or a length L2 and/or a thickness T2; and
wherein W1≠W2 and/or L1≠L2 and/or T1≠T2.

23. (canceled)

24. (canceled)

25. A component of an aerosol provision device comprising:
a non-planar support having one or more laser activated regions.

26-46. (canceled)

47. An aerosol generator comprising:
a component of an aerosol provision device as claimed in claim 25.

48. The aerosol generator of claim 47, wherein the aerosol generator comprises one or more inductive heating elements.

49. An aerosol provision device comprising:
an aerosol generator as claimed in claim 47.

50. An aerosol provision system comprising:
an aerosol provision device as claimed in claim 49; and
an aerosol generating article for generating an aerosol.

51. A method of generating an aerosol comprising:
providing an aerosol provision device as claimed in claim 50; and
at least partially inserting an aerosol generating article for generating an aerosol within the aerosol provision device.

52. (canceled)
